(19) United States
(12) Patent Application Publication
(10) Pub. No.: US 2003/0001020 A1
(43) Pub. Date: Jan. 2, 2003

(54) Paper identification information to associate a printed application with an electronic application

(76) Inventor: James P. Kardach, Saratoga, CA (US)

Correspondence Address: Michael J. Mallie, BLAKELY, SOKOLOFF, TAYLOR & ZAFMAN LLP, Seventh Floor, 12400 Wilshire Boulevard, Los Angeles, CA, 90025-1026, US

(21) Appl. No.: 09/894,520

(22) Filed: Jun. 27, 2001

(51) Int. Cl. G06K 19/06

(52) U.S. Cl. 235/494

(57) ABSTRACT

A method and apparatus are disclosed for taking an electronic application programs such as, for example, PowerPoint, Outlook, Windows, and Word of Microsoft Corporation of Redmond, Wash., and printing them on a piece of paper having a preprinted pattern thereon, thereby creating a hardcopy representation. The hardcopy representation of the application includes identification information (e.g., a unique ID). The identification information associates the application printed on the page with the preprinted pattern on the paper. Using a special pen, edits may be made to the hardcopy representation. The pen records these edits and sends the updates to a computer system automatically. In response to the receiving the edits, the computer system updates the electronic application automatically.

### FIELD OF THE INVENTION

The present invention relates to the field of printing hardcopy representations of electronic applications; more particularly, the present invention relates to taking an electronic application program and printing them on a piece of paper having a preprinted pattern thereon and automatically updating the electronic application with edits made to the hardcopy representation.

### BACKGROUND OF THE INVENTION

Recently, a company named Anoto developed a Bluetooth-equipped pen writing system. [insert Bluetooth cite] This writing system allows vendors to create pen services that are enabled by end users writing on specially encoded paper with the Anoto pen. The paper is encoded with a unique dot pattern (the full dot pattern is extremely large). By the pen reading these dots, through an integrated camera, the pen system can associate a particular function or application with this unique position within the pattern. The pen sends this position information to the internet (via a Bluetooth link to a cellphone, personal digital assistant (PDA) or personal computer (PC)) where a Paper Lookup Server (PLS) associates the particular pattern location with a service to be performed, and sends the information along to a server that then performs the desired services. An example of such a service could be a sheet of paper that has a writing field, an address field, and send button. A user would take this sheet of paper and create a memo by writing in the “writing field” (e.g. Hi Mom, will be home at 8), writing an address in the “address field” (e.g., Mom@home.com) and then checking the “send” box. Once the “send” command was executed the pen would then send the data to the PLS which would direct the data to an application server (called a “Composer” by Anoto) which turns the address field to ASCII and then creates an email with the contents of the “writing field” which is sent to the address field. The end result is that an email is sent to Mom@home.com. The pen system is flexible in that by using a different pattern on the paper, and directing the contents to a different Composer, a variety of different services could be created (for example a translation from English to Spainish prior to sending the email, or the addition of “Email”, “FAX” or “SMS” check boxes to allow the message to be delivered through different means.).

In the current implementations the paper is preprinted for a predefined application (like a notepad that provides the email functions described in the example above); it does not provide a mechanism to associate a printed piece of paper with an application in an ad-hoc fashion. For example, the current Anoto system can be used easily with pre-printed calendars, however a great majority of users print their calendars from a PC with their current itinerary. The current Anoto approach does not provide a good mechanism to allow the ad-hoc creation of printed material such that changes to this “ad-hoc” printed material (e.g., a calendar) are reflected back into the original electronic master.

### BRIEF DESCRIPTION OF THE DRAWINGS

The present invention will be understood more fully from the detailed description given below and from the accompanying drawings of various embodiments of the invention, which, however, should not be taken to limit the invention to the specific embodiments, but are for explanation and understanding only.

FIG. 1 is a flow diagram of one embodiment of the process for automatically updating an electronic application when making edits to a hardcopy representation of that application.

FIG. 2 is a pictorial illustration of the process flow of printing a hardcopy representation of an electronic application.

FIG. 3 illustrates an example of a hardcopy representation.

FIG. 4 illustrates another example of a hardcopy representation.

FIG. 5 is a block diagram of one embodiment of a pen.

FIG. 6 is a block diagram of one embodiment of a computer system.

### DETAILED DESCRIPTION OF THE PRESENT INVENTION

A method and apparatus are disclosed for taking an electronic application program such as, for example, PowerPoint, Outlook, Windows, and Word of Microsoft Corporation of Redmond, Wash., or any PC application, and printing them on a piece of paper having a preprinted pattern thereon, thereby creating a hardcopy representation. The hardcopy representation of the application includes identification information (e.g., a unique ID). The identification information associates the application printed on the page with the preprinted pattern on the paper. Using a special pen, edits may be made to the hardcopy representation. The pen records these edits and sends the updates to a computer system automatically. In response to the receiving the edits, the computer system updates the electronic application automatically.

In the following description, numerous details are set forth to provide a thorough understanding of the present invention. It will be apparent, however, to one skilled in the art, that the present invention may be practiced without these specific details. In other instances, well-known structures and devices are shown in block diagram form, rather than in detail, in order to avoid obscuring the present invention.

Some portions of the detailed descriptions that follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

A machine-readable medium includes any mechanism for storing or transmitting information in a form readable by a machine (e.g., a computer). For example, a machine-readable medium includes read only memory (“ROM”); random access memory (“RAM”); magnetic disk storage media; optical storage media; flash memory devices; electrical, optical, acoustical or other form of propagated signals (e.g., carrier waves, infrared signals, digital signals, etc.); etc.

### Overview

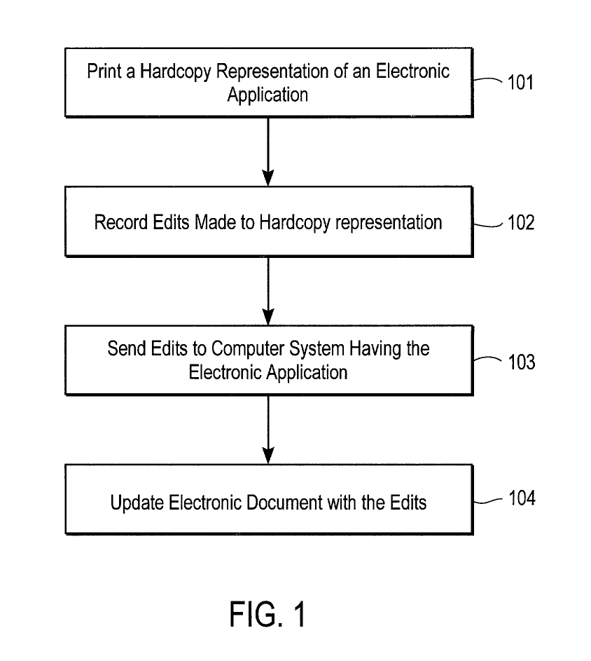

The present invention provides a technique by which edits made to a hardcopy representation of an electronic application may be reflected automatically in the electronic application. FIG. 1 is a flow diagram of one embodiment of the process for automatically updating an electronic application when making edits to a hardcopy representation of that application. The process depicted in FIG. 1 is performed by processing logic that that may comprise hardware (e.g., circuitry, logic, etc.), software (such as is run on a general purpose machine or a dedicated machine), or a combination of both.

Referring to FIG. 1, the process begins by processing logic printing a hardcopy representation of an electronic application on a paper that has a printed pattern and identification information thereon (processing block 101). The printed pattern may be preprinted on the paper prior to the electronic application being printed on the paper or may be printed on the paper at the same time as the electronic application. In one embodiment, the printed pattern is a pattern of dots. The pattern of dots may be an Anoto pattern. Alternatively, the pattern may be applied to the paper using a technique other than printing.

The identification information associates the printed pattern on the paper with the electronic application. In one embodiment, the identification information comprises an ID that is unique to the electronic application. In one embodiment, the ID is printed with an icon on the hardcopy representation.

The identification information may be printed anywhere on the paper, such as, for example, the corner or side of the paper. In one embodiment, the identification information is printed in a corner of the hardcopy representation at a location that does not include any portion of the printed pattern. This is important to ensure that the pen is able to process the identification information without the potential confusion caused by the printed pattern. This allows the printed material to be associated with the pre-printed pattern on the paper by the user drawing a line in this ID field. The pen will recognize the ID pattern and the paper pattern, and will then be able to associate the paper (with its unique pattern) with the application that printed information on the paper (via the ID pattern).

Using the hardcopy representation, processing logic records one or more edits made to the hardcopy representation using a pen by recording movements of the pen with respect to the printed pattern (processing block 102).

In one embodiment, recording pen movements causes camera images of the printed pattern to be created. These camera images are used by the pen/local PLS (a Paper Look-up server located on the PC) to calculate the exact position of the pen as the pen is used to create the one or more edits. Thus, the pen strokes themselves are not recorded, but portions of the printed pattern are recorded from which the edits are recreated by the processing in the pen.

Thereafter, processing logic automatically sends any edits made to the hardcopy representation to the computer system from which the hardcopy representation of the electronic application was created (processing block 103). In one embodiment, the edits are sent to the computer system via wireless transmission. The wireless transmission that may be employed may comprise Bluetooth technology in its current form, but could be transmitted by almost any cable technology (serial cable, universal serial bus (USB), etc.).

Once the edits have been received, an electronic document corresponding to the hardcopy representation is updated with the edits (processing block 104).

Prior to making edits, the user configures the hardcopy representation to the electronic application by performing a pen stroke over the identification information. That is, the user draws a line over or near the identification information (or over or near the icon that is printed with it, and this action causes the pen to record the identification information by noting the pattern of the paper and the pattern of the ID, thus establishing the relationship of associating the ID to the pre-printed paper pattern.

In one embodiment, the printed pattern on the sheets is always the same regardless of the electronic application being printed thereon. However, that is not a requirement. Also, if the hardcopy representation comprises multiple pages, then there is a new ID put on each page. That is, if the hardcopy representation comprises a ten page document, then ten unique IDs are used and each ID represents the page on which it is printed. In such a case, the dots in the pattern have the same context, but the ID associates the unique context that was created on the computer system with the electronic application.

In one embodiment, if a different printed pattern is used for each application, then an individual may make edits to multiple hardcopy representations of different electronic applications in succession without having put a mark at or near the icons that are positioned near the identification information for each paper prior to making edits on that page.

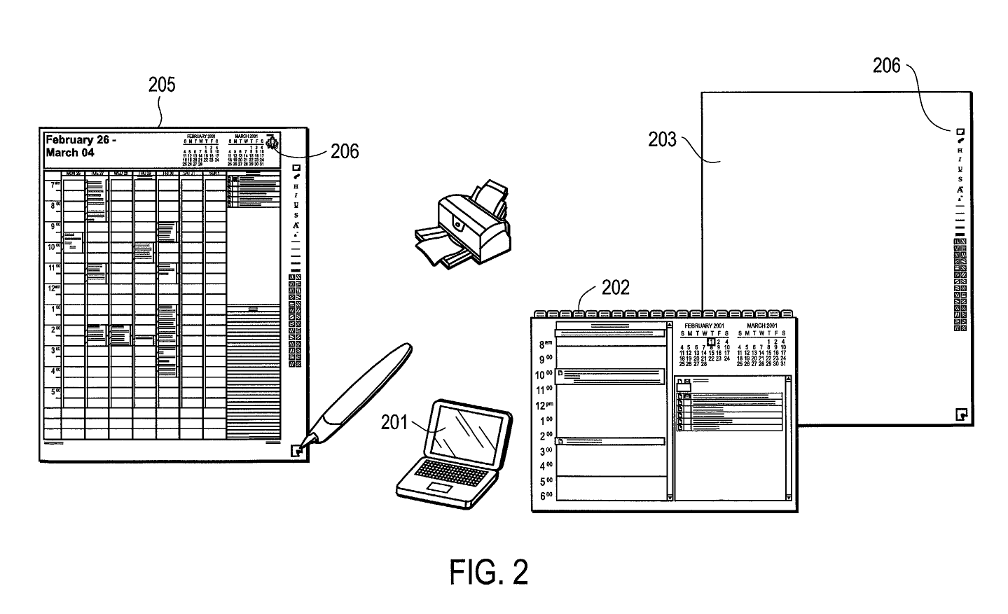

FIG. 2 is an exemplary illustration of the process in which a computer 201 with an application 202 uses printer in conjunction with the paper 203 to print an application such as, for example, a calendaring program to generate hardcopy representation 205. Paper 203 includes the printed pattern (e.g., pattern of dots, Anoto pattern).

Icon 206 is printed on the hardcopy representation. The unique ID is printed in the location on top of the icon in an area of the paper that does not include a preprinted pattern.

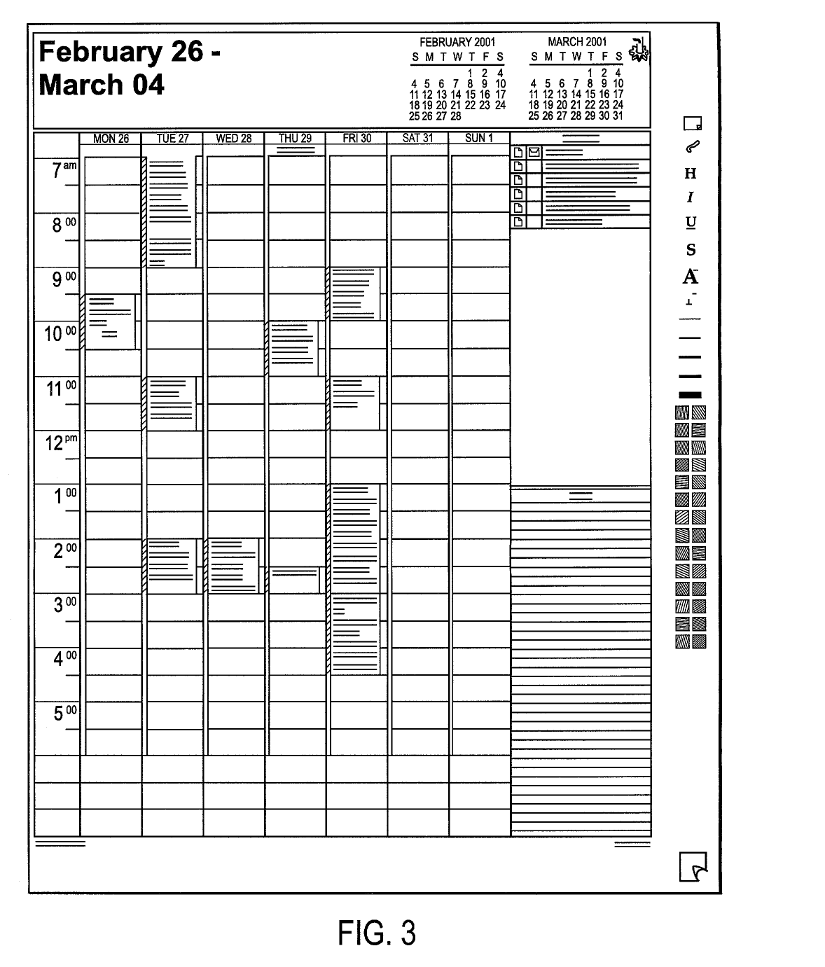

In one embodiment the paper also includes control fields 207. Each of these control fields may be used to enable the pen to be used to select specific functions. These functions may include selection of colors, and control attributes (e.g. “Insert a comment”, “Insert a footnote”, . . . ). FIG. 3 illustrates one embodiment of a hardcopy representation 205.

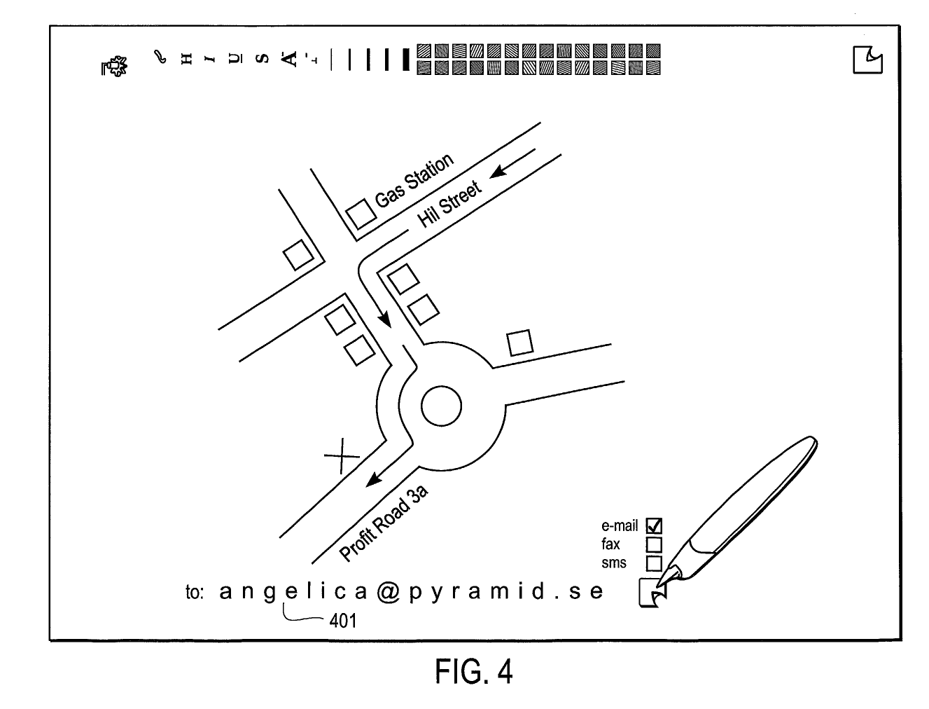

The hardcopy representation may also include fields that will be subjected to OCR. An example of such fields is shown as fields 401 in FIG. 4.

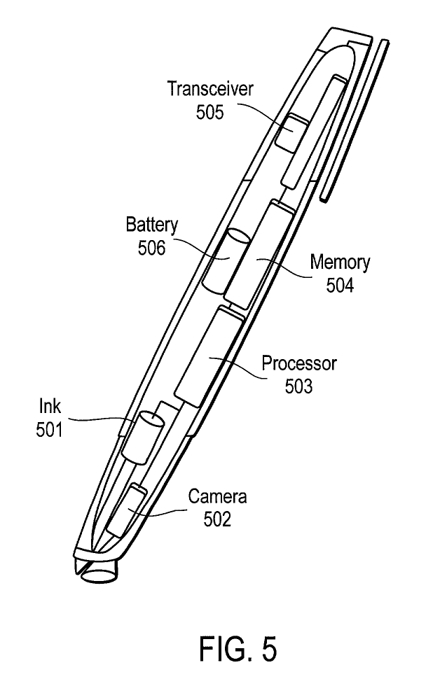

FIG. 5 illustrates one embodiment of a pen that may be used to make edits to the hardcopy representation. Such a pen is similar to an Anoto pen. Referring to FIG. 5, the pen includes an inkwell 501 for dispensing ink from the pen, a camera 502 to create images of the unique pattern (e.g., Anoto pattern) on the hardcopy representation as well as the ID, and a processor 503 coupled to the camera to control the operation of the camera in a manner well known in the art. Processor 503 is also coupled to memory 504 to store the images created by camera 502. A transceiver 505 is coupled to memory 504 to send captured images and other information to a computer system. In one embodiment, transceiver 503 comprises a Bluetooth transceiver that sends information stored in memory 504 to a computer system via wireless communication. A battery 506 is also shown which powers the components in the pen.

When the pen draws a line across the ID icon, it reads the ID pattern and then the paper pattern, which are both part of this larger pattern discussed above. The ID icon pattern location will be associated with the printed application, while the paper pattern will be associated with a blank page function. When the pen recognizes a pen stroke between these two pattern areas, the local composer will then associate that paper pattern with the meaning assigned it via the ID pattern. During the creation of the paper application (i.e., when it was printed), the computer will have stored paper pattern information associated with the functions to be performed (e.g., writing in this pattern area means to create an appointment).

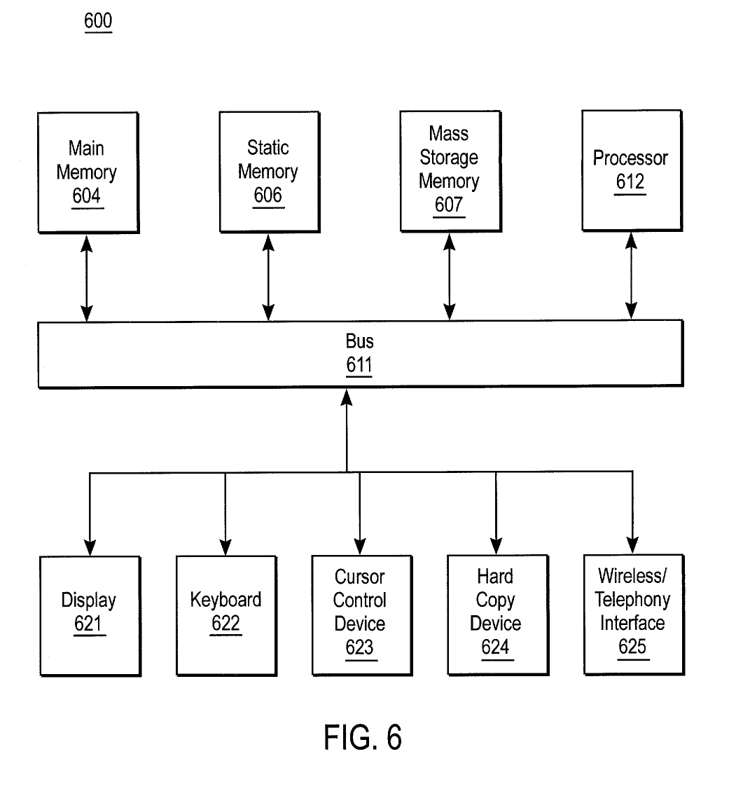

FIG. 6 is a block diagram of an exemplary computer system that may perform one or more of the operations described herein. Referring to FIG. 6, computer system 600 may comprise an exemplary client 650 or server 600 computer system. Computer system 600 comprises a communication mechanism or bus 611 for communicating information, and a processor 612 coupled with bus 611 for processing information. Processor 612 includes a microprocessor, but is not limited to a microprocessor, such as, for example, Pentium™, PowerPC™, Alpha™, etc.

System 600 further comprises a random access memory (RAM), or other dynamic storage device 604 (referred to as main memory) coupled to bus 611 for storing information and instructions to be executed by processor 612. Main memory 604 also may be used for storing temporary variables or other intermediate information during execution of instructions by processor 612.

Computer system 600 also comprises a read only memory (ROM) and/or other static storage device 606 coupled to bus 611 for storing static information and instructions for processor 612, and a data storage device 607, such as a magnetic disk or optical disk and its corresponding disk drive. Data storage device 607 is coupled to bus 611 for storing information and instructions.

Computer system 600 may further be coupled to a display device 621, such as a cathode ray tube (CRT) or liquid crystal display (LCD), coupled to bus 611 for displaying information to a computer user. An alphanumeric input device 622, including alphanumeric and other keys, may also be coupled to bus 611 for communicating information and command selections to processor 612. An additional user input device is cursor control 623, such as a mouse, trackball, trackpad, stylus, or cursor direction keys, coupled to bus 611 for communicating direction information and command selections to processor 612, and for controlling cursor movement on display 621.

Another device that may be coupled to bus 611 is hard copy device 624, which may be used for printing instructions, data, or other information on a medium such as paper, film, or similar types of media. Furthermore, a sound recording and playback device, such as a speaker and/or microphone may optionally be coupled to bus 611 for audio interfacing with computer system 600. Another device that may be coupled to bus 611 is a wired/wireless communication capability 625 to communication to a phone or handheld palm device.

Note that any or all of the components of system 600 and associated hardware may be used in the present invention. However, it can be appreciated that other configurations of the computer system may include some or all of the devices.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims which in themselves recite only those features regarded as essential to the invention.

### Appendix A

William E. Alford, Reg. No. 37,764; Farzad E. Amini, Reg. No. 42,261; William Thomas Babbitt, Reg. No. 39,591; Carol F. Barry, Reg. No. 41,600; Jordan Michael Becker, Reg. No. 39,602; Lisa N. Benado, Reg. No. 39,995; Bradley J. Bereznak, Reg. No. 33,474; Michael A. Bernadicou, Reg. No. 35,934; Roger W. Blakely, Jr., Reg. No. 25,831; R. Alan Burnett, Reg. No. 46,149; Gregory D. Caldwell, Reg. No. 39,926; Thomas M. Coester, Reg. No. 39,637; Donna Jo Coningsby, Reg. No. 41,684; Florin Corie, Reg. No. 46,244; Mimi Diemmy Dao, Reg. No. 45,628; Dennis M. deGuzman, Reg. No. 41,702; Stephen M. De Klerk, Reg. No. 46,503; Michael Anthony DeSanctis, Reg. No. 39,957; Daniel M. De Vos, Reg. No. 37,813; Justin M. Dillon, Reg. No. 42,486; Sanjeet Dutta, Reg. No. 46,145; Matthew C. Fagan, Reg. No. 37,542; Tarek N. Fahmi, Reg. No. 41,402; Thomas S. Ferrill, Reg. No. 42,532; George Fountain, Reg. No. 37,374; James Y. Go, Reg. No. 40,621; James A. Henry, Reg. No. 41,064; Libby N. Ho, Reg. No. 46,774; Willmore F. Holbrow III, Reg. No. 41,845; Sheryl Sue Holloway, Reg. No. 37,850; George W Hoover II, Reg. No. 32,992; Eric S. Hyman, Reg. No. 30,139; William W. Kidd, Reg. No. 31,772; Sang Hui Kim, Reg. No. 40,450; Walter T. Kim, Reg. No. 42,731; Eric T. King, Reg. No. 44,188; George Brian Leavell, Reg. No. 45,436; Kurt P. Leyendecker, Reg. No. 42,799; Gordon R. Lindeen III, Reg. No. 33,192; Jan Carol Little, Reg. No. 41,181; Robert G. Litts, Reg. No. 46,876; Julio Loza, Reg. No. P47,758; Joseph Lutz, Reg. No. 43,765; Michael J. Mallie, Reg. No. 36,591; Andre L. Marais, Reg. No. P048,095; Paul A. Mendonsa, Reg. No. 42,879; Clive D. Menezes, Reg. No. 45,493; Chun M. Ng, Reg. No. 36,878; Thien T. Nguyen, Reg. No. 43,835; Thinh V. Nguyen, Reg. No. 42,034; Robert B. O'Rourke, Reg. No. 46,972; Daniel E. Ovanezian, Reg. No. 41,236; Kenneth B. Paley, Reg. No. 38,989; Gregg A. Peacock, Reg. No. 45,001; Marina Portnova, Reg. No. 45,750; William F. Ryann, Reg. 44,313; James H. Salter, Reg. No. 35,668; William W. Schaal, Reg. No. 39,018; James C. Scheller, Reg. No. 31,195; Jeffrey S. Schubert, Reg. No. 43,098; George Simion, Reg. No. P47,089; Maria McCormack Sobrino, Reg. No. 31,639; Stanley W. Sokoloff, Reg. No. 25,128; Judith A. Szepesi, Reg. No. 39,393; Edwin H. Taylor, Reg. No. 25,129; John F. Travis, Reg. No. 43,203; Joseph A. Twarowski, Reg. No. 42,191; Mark C. Van Ness, Reg. No. 39,865; Tom Van Zandt, Reg. No. 43,219; Brent E. Vecchia, Reg. No. P48,01 1; Lester J. Vincent, Reg. No. 31,460; Archana B. Vittal, Reg. No. 45,182; Glenn E. Von Tersch, Reg. No. 41,364; John Patrick Ward, Reg. No. 40,216; Mark L. Watson, Reg. No. 46,322; Thomas C. Webster, Reg. No. 46,154; and Norman Zafman, Reg. No. 26,250; my patent attorneys, and Firasat Ali, Reg. No. 45,715; and Raul Martinez, Reg. No. 46,904, my patent agents, of BLAKELY, SOKOLOFF, TAYLOR & ZAFMAN LLP, with offices located at 12400 Wilshire Boulevard, 7th Floor, Los Angeles, California 90025, telephone (310) 207-3800, and Alan K. Aldous, Reg. No. 31,905; Ben Burge, Reg. No. 42,372; Richard C. Calderwood, Reg. No. 35,468; Paul W. Churilla, Reg. No. P47,495; Jeffrey S. Draeger, Reg. No. 41,000; Cynthia Thomas Faatz, Reg No. 39,973; John N. Greaves, Reg. No. 40,362; Seth Z. Kalson, Reg. No. 40,670; David J. Kaplan, Reg. No. 41,105; John Kacvinsky, Reg. No. 40,040; Peter Lam, Reg. No. 44,855; Charles A. Mirho, Reg. No. 41,199; Paul Nagy, Reg. No. 37,896; Leo V. Novakoski, Reg. No. 37,198; Thomas C. Reynolds, Reg. No. 32,488; Kenneth M. Seddon, Reg. No. 43,105; Mark Seeley, Reg. No. 32,299; Steven P. Skabrat, Reg. No. 36,279; Howard A. Skaist, Reg. No. 36,008; Steven C. Stewart, Reg. No. 33,555; Gene I. Su, Reg. No. 45,140; Calvin E. Wells, Reg. No. P43,256, Raymond J. Werner, Reg. No. 34,752; Robert G. Winkle, Reg. No. 37,474; Sharon Wong, Reg. No. 37,760; Steven D. Yates, Reg. No. 42,242; and Charles K. Young, Reg. No. 39,435; my patent attorneys, and Michael J. Nesheiwat, Reg. No. P47,819, my patent agent of INTEL CORPORATION; and James R. Thein, Reg. No. 31,710, my patent attorney with full power of substitution and revocation, to prosecute this application and to transact all business in the Patent and Trademark Office connected herewith.

### Appendix B

### Title 37, Code of Federal Regulations, Section 1.56 Duty to Disclose Information Material to Patentability

(a) A patent by its very nature is affected with a public interest. The public interest is best served, and the most effective patent examination occurs when, at the time an application is being examined, the Office is aware of and evaluates the teachings of all information material to patentability. Each individual associated with the filing and prosecution of a patent application has a duty of candor and good faith in dealing with the Office, which includes a duty to disclose to the Office all information known to that individual to be material to patentability as defined in this section. The duty to disclose information exists with respect to each pending claim until the claim is cancelled or withdrawn from consideration, or the application becomes abandoned. Information material to the patentability of a claim that is cancelled or withdrawn from consideration need not be submitted if the information is not material to the patentability of any claim remaining under consideration in the application. There is no duty to submit information which is not material to the patentability of any existing claim. The duty to disclose all information known to be material to patentability is deemed to be satisfied if all information known to be material to patentability of any claim issued in a patent was cited by the Office or submitted to the Office in the manner prescribed by §§1.97(b)-(d) and 1.98. However, no patent will be granted on an application in connection with which fraud on the Office was practiced or attempted or the duty of disclosure was violated through bad faith or intentional misconduct. The Office encourages applicants to carefully examine:

(1) Prior art cited in search reports of a foreign patent office in a counterpart application, and

(2) The closest information over which individuals associated with the filing or prosecution of a patent application believe any pending claim patentably defines, to make sure that any material information contained therein is disclosed to the Office.

(b) Under this section, information is material to patentability when it is not cumulative to information already of record or being made of record in the application, and

(1) It establishes, by itself or in combination with other information, a prima facie case of unpatentability of a claim; or

(2) It refutes, or is inconsistent with, a position the applicant takes in:

(i) Opposing an argument of unpatentability relied on by the Office, or

(ii) Asserting an argument of patentability.

A prima facie case of unpatentability is established when the information compels a conclusion that a claim is unpatentable under the preponderance of evidence, burden-of-proof standard, giving each term in the claim its broadest reasonable construction consistent with the specification, and before any consideration is given to evidence which may be submitted in an attempt to establish a contrary conclusion of patentability.

(c) Individuals associated with the filing or prosecution of a patent application within the meaning of this section are:

(1) Each inventor named in the application;

(2) Each attorney or agent who prepares or prosecutes the application; and

(3) Every other person who is substantively involved in the preparation or prosecution of the application and who is associated with the inventor, with the assignee or with anyone to whom there is an obligation to assign the application.

(d) Individuals other than the attorney, agent or inventor may comply with this section by disclosing information to the attorney, agent, or inventor.

(e) In any continuation-in-part application, the duty under this section includes the duty to disclose to the Office all information known to the person to be material to patentability, as defined in paragraph (b) of this section, which became available between the filing date of the prior application and the national or PCT international filing date of the continuation-in-part application.

I claim:

1. A method comprising:
printing a hardcopy representation of an electronic application on a paper having a printed pattern thereon, the hardcopy representation having identification information to associate the hardcopy representation with the electronic application;
recording one or more edits made with a pen on the hardcopy representation by recording movements of the pen with respect to the printed pattern; and
automatically sending the one or more edits made on the hardcopy representation, via wireless transmission, to a computer system.

2. The method defined in claim 1 further comprising recording the identification information with the pen prior to making the one or more edits.

3. The method defined in claim 2 wherein recording the identification information comprises making a mark with the pen in the area with the identification information.

4. The method defined in claim 3 wherein making a mark with a pen comprises writing a line at least to an icon on the hardcopy representation.

5. The method defined in claim 1 further comprising incorporating the one or more changes into an electronic version of the hardcopy representation.

6. The method defined in claim 5 further comprising incorporating the one or more changes into the electronic version of the hardcopy representation automatically without end user intervention through the use of a pen/paper interface.

7. The method defined in claim 1 wherein the identification information comprises an ID printed with an icon on the hardcopy representation.

8. The method defined in claim 1 wherein the identification information is printed in a corner of the hardcopy representation.

9. The method defined in claim 1 wherein the identification information is on the paper at a location that does not include any portion of the printed pattern.

10. The method defined in claim 1 wherein the printed pattern comprises a pattern of dots.

11. The method defined in claim 1 wherein the unique pattern comprises an Anoto pattern.

12. The method defined in claim 1 further comprising locating position of the edits from camera images.

13. The method defined in claim 1 wherein recording the pen movements comprises creating camera images of portions of the pattern proximate to the pen to enable calculation of an exact position of the pen as the pen is used to create the one or more edits.

14. A method comprising:
printing a hardcopy representation of an electronic application on a paper having a printed pattern thereon, the hardcopy representation having identification information to associate the hardcopy representation with the electronic application;
recording the identification information with the pen prior to making the one or more edits;
recording one or more edits made with a pen on the hardcopy representation by recording movements of the pen with respect to the printed pattern;
automatically sending the one or more edits made on the hardcopy representation, via wireless transmission, to a computer system; and
incorporating the one or more changes into the electronic version of the hardcopy representation automatically without end user intervention through the use of a pen/paper interface.

15. The method defined in claim 14 wherein recording the identification information comprises making a mark with the pen in the area with the identification information.

16. The method defined in claim 15 wherein making a mark with a pen comprises writing a line at least to an icon on the hardcopy representation.

17. The method defined in claim 14 wherein the identification information comprises an ID printed with an icon on the hardcopy representation.

18. The method defined in claim 14 wherein the identification information is printed in a corner of the hardcopy representation.

19. The method defined in claim 14 wherein the identification information is on the paper at a location that does not include any portion of the printed pattern.

20. The method defined in claim 14 wherein the printed pattern comprises a pattern of dots.

21. The method defined in claim 14 wherein the unique pattern comprises an Anoto pattern.

22. The method defined in claim 14 further comprising locating position of the edits from camera images.

23. The method defined in claim 14 wherein recording the pen movements comprises creating camera images of portions of the pattern proximate to the pen to enable calculation of an exact position of the pen as the pen is used to create the one or more edits.

24. An article of manufacture comprising one or more recordable media with executable instructions stored thereon which, when executed by a system, cause the system to:
print a hardcopy representation of an electronic application on a paper having a printed pattern thereon, the hardcopy representation having identification information to associate the hardcopy representation with the electronic application;
record one or more edits made with a pen on the hardcopy representation by recording movements of the pen with respect to the printed pattern; and
automatically send the one or more edits made on the hardcopy representation, via wireless transmission, to a computer system.

25. The article of manufacture defined in claim 24 further comprising incorporating the one or more changes into the electronic version of the hardcopy representation automatically without end user intervention through the use of a pen/paper interface.
